(19) United States
(12) Patent Application Publication
(10) Pub. No.: US 2014/0005329 A1
(43) Pub. Date: Jan. 2, 2014

(54) Urethane Resin Adhesive Composition

(71) Applicants: Hiroshi Fukui, Hiratsuka-shi (JP); Kiminori Araki, Hiratsuka-shi (JP)

(72) Inventors: Hiroshi Fukui, Hiratsuka-shi (JP); Kiminori Araki, Hiratsuka-shi (JP)

(73) Assignee: The Yokohama Rubber Co., Ltd., Minato-ku, Tokyo (JP)

(21) Appl. No.: 13/988,715

(22) PCT Filed: Aug. 7, 2012
(86) PCT No.: PCT/JP12/70106

§ 371 Date: May 21, 2013

(30) Foreign Application Priority Data
May 24, 2011 (JP) 2011-116090

(51) Int. Cl. C09J 175/04

(52) U.S. Cl. CPC C09J 175/04
USPC 524/590

(57) ABSTRACT

A urethane resin adhesive composition includes a urethane resin including at least two types of multi-functional polyols, at least one type of multi-functional isocyanate, and a thermo-sensitive catalyst functioning catalytically at a temperature greater than or equal to a predetermined temperature in a range greater than or equal to 20° C. and less than or equal to 90° C. The multi-functional polyol includes a first multi-functional polyol having a number average molecular weight greater than or equal to 50 and less than or equal to 800, and a second multi-functional polyol having a number average molecular weight greater than or equal to 1,000 and less than or equal to 4,000. Average OH values of the first multi-functional polyol and the second multi-functional polyol are greater than or equal to 150 and less than or equal to 800.

### TECHNICAL FIELD

The present technology relates to a urethane resin adhesive composition that has high strength, high elongation, and excellent adhesivity.

### BACKGROUND

As weight of vehicle bodies has been reduced for automobiles or the like, there is increasing demand in the marketplace for adhesives that are capable of bonding different types of materials, i.e. bonding aluminum and resins, rather than bonding between steel members by conventional welding methods.

For example, an epoxy resin composition adhesive has been proposed that is capable of use as an adhesive for structural components of an automobile or the like and that has high reliability and little lowering of bonding characteristics even when a high load is applied over a long time interval (e.g., see Japanese Unexamined Patent Application Publication No. 2006-514144). Moreover, a single liquid type moisture-curing urethane composition adhesive has been proposed as a direct glazing material used for bonding together the body and window glass of an automobile (e.g., see Japanese Unexamined Patent Application Publication No. 2006-176664A).

However, the adhesive described in Japanese Unexamined Patent Application Publication No. 2006-514144 has had problems in that, although strength of the epoxy resin composition is high, elongation is low, and thus an adhesive is not obtained that has the expandability needed for a direct glazing material.

Moreover, the adhesive described in Japanese Unexamined Patent Application Publication No. 2006-176664A has had problems in that, although elongation is high since the adhesive is a direct glazing material, strength is low, and thus a high strength adhesive is not obtained in comparison to an epoxy resin composition.

Thus an adhesive composition is needed that satisfies the characteristics of high strength, high elongation, and excellent adhesivity.

### SUMMARY

In consideration of the aforementioned circumstances, the present technology provides a urethane resin adhesive composition that has high strength, high elongation, and excellent adhesivity.

The present technology is described in the following (1) to (3).

(1) A urethane resin adhesive composition including: a urethane resin including at least two types of multi-functional polyols and at least one type of multi-functional isocyanate; and a thermo-sensitive catalyst functioning catalytically at a temperature greater than or equal to a predetermined temperature in a range greater than or equal to 20° C. and less than or equal to 90° C.;

the multi-functional polyols including: a first multi-functional polyol having a number average molecular weight greater than or equal to 50 and less than or equal to 800; and a second multi-functional polyol having a number average molecular weight greater than or equal to 1,000 and less than or equal to 4,000; wherein

average OH values of the first multi-functional polyol and the second multi-functional polyol are greater than or equal to 150 and less than or equal to 800; and

a NCO/OH ratio of the multi-functional isocyanate is greater than or equal to 0.8 and less than or equal to 1.2.

(2) The urethane resin adhesive composition according to claim 1, wherein the thermo-sensitive catalyst includes at least one compound selected from the group consisting of 1,5-diazabicyclo[4,3,0]non-5-ene or salts thereof, and 1,8-diazabicyclo[5,4,0]undec-7-ene or salts thereof

(3) The urethane resin adhesive composition according to claim 1, wherein a content of the first multi-functional polyol relative to a sum of all of the multi-functional polyols is greater than or equal to 5 mass % and less than or equal to 50 mass %.

The present technology has the effect of making it possible to obtain a urethane resin adhesive composition that has high strength, high elongation, and excellent adhesivity.

### DETAILED DESCRIPTION

The present technology is explained in detail below. However, the present technology is not limited by the embodiments of the technology (hereinafter referred to as the “embodiments”) described hereinafter. Furthermore, the constituents described in the embodiments include constituents that could be easily conceived by a person skilled in the art and constituents that are essentially identical, or, in other words, are equivalent in scope. Moreover, the constituents described in the embodiments can be combined as desired.

The urethane resin adhesive composition of the present embodiment is a two-liquid mixed type composition including a main agent and a curing agent. The two-liquid mixed type adhesive composition is capable of rapid curing, and after curing, has excellent heat resistance. From the standpoints of curing speed, post-curing hardness, or the like, a urethane type adhesive composition is preferred as the two-liquid mixed type adhesive composition used in the present embodiment.

The urethane resin adhesive composition of the present embodiment (referred to hereinafter as the adhesive composition of the present embodiment) is a urethane resin adhesive composition including: a urethane resin including at least two types of multi-functional polyols and at least one type of multi-functional isocyanate; and a thermo-sensitive catalyst functioning catalytically at a temperature greater than or equal to a predetermined temperature in a range greater than or equal to 20° C. and less than or equal to 90° C. The multi-functional polyols include: a first multi-functional polyol having a number average molecular weight greater than or equal to 50 and less than or equal to 800; and a second multi-functional polyol having a number average molecular weight greater than or equal to 1,000 and less than or equal to 4,000. Average OH values of the first multi-functional polyol and the second multi-functional polyol are greater than or equal to 150 and less than or equal to 800. A NCO/OH ratio of the multi-functional isocyanate is greater than or equal to 0.8 and less than or equal to 1.2. The components included in the adhesive composition of the present embodiment will be explained below.

### Urethane Resin

No particular limitation is placed on the urethane resin included in the adhesive composition of the present embodiment, and widely known urethane prepolymers may be used that have multiple isocyanate group terminals in the molecule. From the standpoint of handling, the urethane prepolymer is preferably a liquid at room temperature. The urethane prepolymer is a reaction product obtained by reaction between a polyol compound and a polyisocyanate compound so that the isocyanate group (NCO group) is in excess relative to the hydroxy group (OH group), and the urethane prepolymer includes multiple isocyanate groups at the molecular terminals. The urethane prepolymer preferably includes greater than or equal to 0.5 mass % and less than or equal to 5 mass % of isocyanate groups at the molecular terminals. These isocyanate groups may be bonded to either aromatic hydrocarbons or aliphatic hydrocarbons.

### Multi-Functional Polyol

The adhesive composition of the present embodiment includes at least two different multi-functional (i.e. being at least difunctional) polyols having different number average molecular weight. The multi-functional polyols (polyol compounds) included in the adhesive composition of the present embodiment include a first multi-functional polyol having a number average molecular weight greater than or equal to 50 and less than or equal to 800, and a second multi-functional polyol having a number average molecular weight greater than or equal to 1,000 and less than or equal to 4,000. Average OH value of the first multi-functional polyol and the second multi-functional polyol is greater than or equal to 150 and less than or equal to 800.

The content of the first multi-functional polyol, which has an number average molecular weight greater than or equal to 50 and less than or equal to 800, is preferably greater than or equal to 5 mass % and less than or equal to 50 mass % relative to the total of all the multi-functional polyols.

The multi-functional polyol included in the adhesive composition of the present embodiment is referred to as the “polyol compound.”

No particular limitation is placed on the polyol compound, and the polyol compound is exemplified by polyether polyols, polyester polyols, acrylic polyols, polycarbonate polyols, or the like. Such polyols may be used as one type or as a mixture of multiple types. Specific examples of the polyol compound include polypropylene ether diols, polyethylene ether diols, polytetramethylene glycol, polyethylene glycol, polypropylene glycol, polyoxyethylene glycol, polyoxypropylene glycol, polyoxypropylene triol, polyoxybutylene glycol, polytetramethylene ether glycols, polymer polyol, poly(ethylene adipate), poly(diethylene adipate), polypropylene adipate), poly(tetramethylene adipate), poly(hexamethylene adipate), poly(neopentylene adipate), poly-c-caprolactone, poly(hexamethylene carbonate), silicone polyols, or the like. Moreover, natural type polyol compounds may be used such as castor oil or the like. Such polyol compounds may be used as a single type or as a combination of two or more types.

From the standpoint of composition viscosity and excellent physical properties of the cured product of the composition, at least one type of the first polyol compounds preferably is a polyether polyol having a number average molecular weight greater than or equal to 50 and less than or equal to 1,000, further preferably having a number average molecular weight greater than or equal to 50 and less than or equal to 900, and most preferably having a number average molecular weight greater than or equal to 50 and less than or equal to 800. The content of the first multi-functional polyol, which has a number average molecular weight greater than or equal to 50 and less than or equal to 800, relative to the total amount of multi-functional polyols in the adhesive composition of the present embodiment, is preferably greater than or equal to 5 mass % and less than or equal to 50 mass %.

Moreover, at least one type of the second polyol compounds preferably is a polyether polyol having a number average molecular weight greater than or equal to 1,000 and less than or equal to 5,000, further preferably having a number average molecular weight greater than or equal to 1,000 and less than or equal to 10,000, and most preferably having a number average molecular weight greater than or equal to 1,000 and less than or equal to 4,000.

Note that, in this embodiment, number average molecular weight is measured by the gel permeation chromatography (GPC) method.

### Multi-Functional Isocyanate

The adhesive composition of the present embodiment includes a multi-functional isocyanate having at least two functional groups (i.e. isocyanate compound). The multi-functional isocyanate included in the adhesive composition of the present embodiment is a polyisocyanate having at least two isocyanate groups. Moreover, the blended amount of the multi-functional isocyanate included in the adhesive composition of the present embodiment is such that the NCO/OH ratio is greater than or equal to 0.8 and less than or equal to 1.2. The multi-functional isocyanate included in the adhesive composition of the present embodiment is termed the “polyisocyanate compound.”

No particular limitation is placed on the polyisocyanate compound used in the synthesis of the adhesive composition used in the present embodiment, as long as the polyisocyanate compound is used in the production of a urethane type prepolymer and has two or more isocyanate groups within the molecule. The polyisocyanate compound is exemplified by aromatic polyisocyanates having isocyanate groups bonded to an aromatic hydrocarbon, aliphatic polyisocyanates having isocyanate groups bonded to an aliphatic hydrocarbon, alicyclic polyisocyanates having isocyanate groups bonded to an alicyclic hydrocarbon, or the like. The aromatic polyisocyanate is exemplified by TDI (such as 2,4-tolylene diisocyanate (2,4-TDI), 2,6-tolylene diisocyanate (2,6-TDI), mixtures thereof, or the like toluene diisocyanates), MDI (such as 4,4′-diphenylmethane diisocyanate (4,4′-MDI), 2,4′-diphenylmethane diisocyanate (2,4′-MDI), mixtures thereof, or the like diphenylmethane diisocyanates), 1,4-phenylene diisocyanate, diphenyl diisocyanate, polymethylene polyphenylene polyisocyanate, tolidine diisocyanate (TODI), 1,5-naphthalene diisocyanate (1,5-NDI); diphenyl ether diisocyanate, triphenylmethane triisocyanate, or the like. The aliphatic polyisocyanate is exemplified by propylene diisocyanate, butylene diisocyanate, hexamethylene diisocyanate (HDI), pentamethylene diisocyanate, trimethylhexamethylene diisocyanate (TMHDI), lysine diisocyanate, norbornane diisocyanate (NBDI) xylylene diisocyanate (XDI), tetramethylxylylene diisocyanate (TMXDI), or the like. The alicyclic polyisocyanate is exemplified by cyclohexane diisocyanate, methylene-bis(cyclohexylisocyanate), trans-cyclohexane-1,4-diisocyanate, isophorone diisocyanate (IPDI), bis(isocyanatemethyl)cyclohexane (H₆XDI), dicyclohexylmethane diisocyanate (H₁₂MDI), or the like. Further examples include carbodiimide-modified polyisocyanates, biuret-modified polyisocyanates, allophanate-modified polyisocyanates, polymethylene polyphenyl polyisocyanates (crude MDI or polymeric MDI), and isocyanurate-modified polyisocyanates of such aromatic polyisocyanates, aliphatic polyisocyanates, and alicyclic polyisocyanates, or the like.

Such polyisocyanate compounds may be used as one type or as a combination of two or more types. Of these polyisocyanate compounds, to reach a low viscosity after the reaction and for ease in handling of the main agent including the urethane type prepolymer, TDI and MDI are preferable among the aromatic polyisocyanates, HDI and XDI are preferable among the aliphatic polyisocyanates, and IPDI is preferable among the alicyclic polyisocyanates. From the standpoints of ready procurement and low cost, the polyisocyanate compound is preferably 4,4′-diphenylmethane diisocyanate.

No particular limitation is placed on the combination of the polyol compound and the polyisocyanate compound, and any combination may be used of the respective polyol compounds and polyisocyanate compounds. For example, a urethane prepolymer obtained from polypropylene glycol and MDI is preferred from the standpoints of ready procurement, cost, and adjustment of physical properties.

The mole ratio (NCO/OH ratio) of the isocyanate (NCO) groups in the polyisocyanate compound over the hydroxy (OH) groups in the polyol compound for the mixture of the polyol compound and polyisocyanate compound is greater than or equal to 0.8 and less than or equal to 1.2, and preferably is greater than or equal to 0.9 and less than or equal to 1.1. Viscosity of the urethane prepolymer is appropriate, and elongation of the cured product is excellent, when the NCO/OH ratio is within the aforementioned range.

No particular limitation is placed on the reaction between the polyol compound and the polyisocyanate compound. For example, a method is cited of production by stirring and heating the polyol compound and the polyisocyanate compound at the aforementioned content ratio at a temperature greater than or equal to 30° C. and less than or equal to 120° C., and preferably greater than or equal to 50° C. and less than or equal to 100° C.

The polyurethane resin (i.e. product of the aforementioned reaction) preferably has excellent initial adhesivity. The polyurethane resin is prepared by copolymerizing monomers by urethane bonding formed by condensation between the isocyanate group and alcohol group, and no particular limitation is placed on the polyurethane resin as long as the number average molecular weight is greater than or equal to 15,000.

### Thermo-Sensitive Catalyst

The thermo-sensitive catalyst included in the adhesive composition of the present embodiment may be any type of widely known catalyst, as long as the catalyst is a thermo-sensitive catalyst having activity when heated that exceeds normal activity. So-called slow-acting catalysts, heat-sensitive catalysts and the like are preferably used. The thermo-sensitive catalyst is used to promote reactions such as the resin reaction between the polyol compound and the polyisocyanate compound, and thus the thermo-sensitive catalyst may exhibit catalyst function according to temperature conditions. A thermo-sensitive catalyst is used with advantage that is capable of exhibiting catalyst function particularly when heated to a temperature greater than or equal to a predetermined temperature in a range greater than or equal to 20° C. and less than or equal to 90° C. Thermo-sensitive catalysts are exemplified by: blocked catalysts formed by partial or total neutralization of amine catalysts by carboxylic acids, thermo-active catalysts that are normally terminated but forming an amine catalyst due to heating, and thermo-sensitive catalysts that have increased catalyst activity due to lowering of steric hindrance of the molecule due to heating, approach of an electron pair to a nitrogen molecule due to heating, lowering of hydrogen bonding due to heating, or the like.

The following amine type catalysts are suitable examples of the thermo-sensitive catalyst. Specific examples of the thermo-sensitive catalyst include: diazabicyclo-alkenes having an amidino group [H₂NC(═NH)—] such as 1,5-diazabicyclo[4,3,0]non-5-ene (DBN) expressed by the following Formula (1), 1,8-diazabicyclo[5,4,0]undec-7-ene (DBU) expressed by the following Formula (3), or the like, and salts thereof; triethylenediamine; mixtures of triethylenediamine and polypropylene glycol; and imidazoles such as 1-methylimidazole, 1,2-dimethylimidazole, 1-isobutyl-2-methylimidazole, or the like. Of these, diazabicyclo-alkenes, phenol salts thereof, octylic acid salts thereof, or the like, which have high catalyst activity, are preferred as the thermo-sensitive catalyst. The salts of the aforementioned DBN are expressed by the following General Formula (2), and the salts of the aforementioned DBU are expressed by the following General Formula (4).

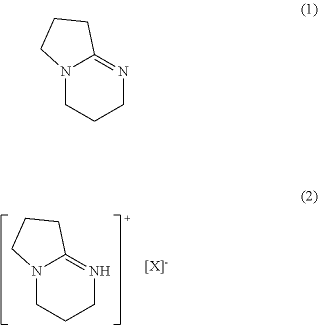

(in the aforementioned General Formula (2), X is an inorganic or organic acid residue group)

X in the aforementioned General Formula (2) is an inorganic acid residue group or organic acid residue group. Typical examples of the aforementioned DBN salt include organic acid salts of DBN such as DBN formate, DBN ortho-phthalate, DBN octylate, DBN phenoxide, DBN phenol novolac resin salt, DBN p-toluene sulfonate, or the like.

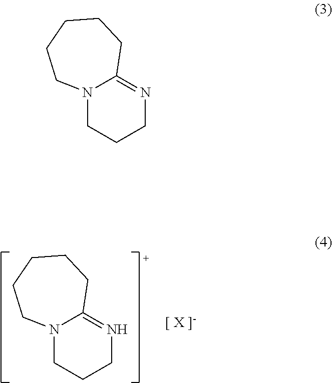

(in the aforementioned General Formula (4), X is an inorganic or organic acid residue group)

In the aforementioned General Formula (4), X is an inorganic or organic acid residue group. Typical examples of the aforementioned DBU salt include organic acid salts of DBU such as DBU formate, DBU oleate, DBU ortho-phthalate, DBU octylate, DBU phenoxide, DBU p-toluene sulfonate, or the like.

This type of thermo-sensitive catalyst can cure the adhesive composition over a short time interval due to the expression of activity of the urethane catalyst suddenly when the thermo-sensitive catalyst is added to the aforementioned urethane resin adhesive composition and heated to a temperature greater than or equal to a certain temperature. Moreover, storage stability improves due to the addition of the aforementioned catalyst. The added amount of the thermo-sensitive catalyst per 100 parts by mass of the urethane prepolymer is preferably greater than or equal to 0.001 parts by mass and less than or equal to 1.0 parts by mass, and further preferably is greater than or equal to 0.05 parts by mass and less than or equal to 0.5 parts by mass.

The aforementioned DBN or salts thereof expressed by General Formula (1) and General Formula (2) are widely known compounds, and due to the ability to use commercial products, there is no particular need for synthesis of these compounds. For example, it is possible to use commercial products such as DBN produced by San-Apro Ltd., as exemplified by U-CAT1102 (DBN octylate), U-CAT881 (DBN phenol novolac resin salt), or the like. The aforementioned DBU or salts thereof expressed by General Formula (3) and General Formula (4) may be commercial products such as those produced by San-Apro Ltd., as exemplified by U-CAT SA102-50 (DBU octylate), U-CAT SA112 (DBU octylate), U-CAT SA106 (DBU oleate), U-CAT SA506 (DBU p-toluene sulfonate), U-CAT SA603 (DBU formate), or the like.

Additional examples include those produced by Air Products Japan Inc., such as U-CAT SA-1, U-CAT SA-102, DABCO 8154, DF, DC-1/DC-2, BL-17, TAC, H-1010, 2002, 2003, X-542, X-543, VP-137, 1027, 1028, NC-1M, NC-EMC, NCX-1072, NCX-1075, or the like.

In addition to the aforementioned thermo-sensitive catalyst, other catalysts may be used as exemplified by other amine catalysts, metal catalysts, or the like. Such other amine type catalysts include: tertiary amine compound triethylamines, N,N-dimethylcyclohexylamine, or the like monoamines; N,N,N′,N′-tetramethylethylenediamine, N,N,N′,N′-tetramethylpropane-1,3-diamine, N,N,N′,N′-tetramethylhexane-1,6-diamine, or the like diamines; N,N,N′,N″,N″-pentamethyldiethylenetriamine, N,N,N′,N″,N″-pentamethyldipropylenetriamine, or the like triamines; N-methylmorpholine, N,N′-dimethylpiperazine, N-methyl-N′-(2-dimethylamino)-ethylpiperazine, or the like alicyclic amines; dimethylaminoethanol, dimethylaminoethoxyethanol, N,N,N′-trimethylaminoethylethanolamine, or the like alcohol amines; bis(2-dimethylaminoethyl)ether, ethylene glycol bis(3-dimethyl)aminopropyl ether, or the like ether amines; and salts of such compounds.

The metal catalyst is exemplified by organometallic compounds such as tin octylate, alkali metal alcoholates, or the like. Examples of metal catalysts include tin carboxylate salts such as dimethyltin dilaurate, dibutyltin dilaurate, dibutyltin maleate, dibutyltin diacetate, tin octylate, tin naphthalate, and the like; titanate esters such as tetrabutyl titanate, tetrapropyl titanate, and the like; organic aluminum compounds such as aluminum tris-acetylacetonate, aluminum tris-ethyl acetoacetate, diisopropoxyaluminum ethyl acetoacetate, and the like; chelate compounds such as zirconium tetra-acetylacetonate, titanium tetra-acetylacetonate, and the like; metal salts of octonoic acid such as lead octanoate, bismuth octonotate, and the like; and the like.

Among such other catalysts, the use of the thermo-sensitive catalyst with another amine catalyst is preferred due to the ability for the resin reaction and foaming reaction to proceed with good balance and due to the ability to obtain a good polyurethane resin.

In the case of an amine catalyst, blended amount of the catalyst per 100 parts by mass of the polyol compound is preferably greater than or equal to 0.05 parts by mass and less than or equal to 1.0 parts by mass. In the case of a metal catalyst, the blended amount is preferably greater than or equal to 0.05 parts by mass and less than or equal to 0.5 parts by mass.

In addition to the aforementioned necessary ingredients, as may be required and as long as suitable working life may be secured, various additives or the like may be optionally included in the adhesive composition of the present embodiment during blending, as exemplified by solvents, antiaging agents, antioxidants, UV absorbents, coloring agents (e.g. pigments, dyes, or the like), softeners, plasticizers, reinforcing agents, fillers, dispersants, dehydrating agents, adhesion promoters, or the like. The additives and the like may be blended according to a general method and used in vulcanizing or cross-linking Compounded amounts of these additives may be any conventional standard amount, so long as the objects of this embodiment are not hindered.

No particular limitation is placed on the method of production of the adhesive composition of the present embodiment. For example, a method can be used in which each of the essential components and the optional components described above are thoroughly mixed in a closed vessel using a mixer such as a combination mixer or the like.

Any method may be used as the method of use of the adhesive composition of the present embodiment as long as the adhesive composition is heated. For example, the adhesive composition of the present embodiment is coated on an adherend. Then, the adherend is attached to a separate article, and both the adherend and the article are pressed together to form a bonded structural article. Thereafter, the bonded structural article is heated, for example at 80° C. for 10 minutes, and then cooled down to room temperature. During this process, the heating temperature and time may be any temperature and time such that the thermo-sensitive catalyst is capable of exhibiting catalytic function when heated to a temperature greater than or equal to a predetermined temperature in a range greater than or equal to 20° C. and less than or equal to 90° C. Furthermore, the heating temperature and time may be set appropriately according to the utilized thermo-sensitive catalyst.

Effects such as those described below are possible by use of the adhesive composition of the present embodiment. It is possible to perform curing over a short time interval due to the thermo-sensitive catalyst by preparing the blend of the multi-functional polyols and the multi-functional isocyanate in the above described manner and then heating to a temperature greater than or equal to a predetermined temperature.

That is to say, a urethane resin adhesive composition that has high strength, high elongation, and excellent adhesivity can be provided by including a urethane resin having at least two types of multi-functional polyols and at least one type of multi-functional isocyanate; and a thermo-sensitive catalyst functioning catalytically at a temperature greater than or equal to a predetermined temperature in a range greater than or equal to 20° C. and less than or equal to 90° C.

The adhesive composition of the present embodiment, in addition to having excellent flexibility and adhesivity from low temperature (i.e. about −20° C.) to room temperature, has excellent flexibility and adhesivity even at high temperature (i.e. about 80° C.). Thus the adhesive composition of the present embodiment can be preferably used as a structural adhesive.

Here, the expression “structural adhesive” is taken to mean an adhesive (JIS K6800) that has high reliability and little lowering of bonding characteristics even when a load is applied over a long time interval.

Thus although no particular limitation is placed on the applications of the adhesive composition of the present embodiment, the adhesive composition may be used suitably as a structural adhesive or the like. The adhesive composition of the present embodiment may be used, for example, as an adhesive for structural components of automobiles or train cars (e.g. bullet train cars and electric train cars), civil construction, construction, building materials, woodworking, electrical applications, electronics, aircraft, space industry applications, or the like. In particular, examples of automobile-related applications include adhesives for the ceiling, door, seats, or the like interior components, and adhesives for exterior materials such as automotive lights (e.g. lamps or the like), side molding, or the like.

Although the urethane resin adhesive composition of the present technology was explained above in detail, the present technology is not limited to the aforementioned examples, and various types of modifications and improvements may be used within a scope that does not depart from the gist of the present technology.

### EXAMPLES

The present technology is described below in detail using working examples but is in no way limited to these examples.

### Preparation of the Urethane Resin Adhesive Composition

Each of the components indicated in Table 1 were blended as the added amounts (parts by mass) indicated in the same table. These components were uniformly blended to prepare each of the urethane resin adhesive compositions indicated in Table 1. The added amounts (parts by mass) of each ingredient in the Working Examples and Comparative Examples are shown in Table 1.

### Evaluation

Each of the compositions of each of the working examples and comparative examples obtained in the aforementioned manner were evaluated by the below indicated methods for post-cure breaking strength, breaking elongation, adhesivity, and foaming performance. The results are shown in Table 1.

### Breaking Strength

Each of the adhesive compositions prepared and obtained in the aforementioned manner was coated on a respective plastic plate at room temperature, was heated for 10 minutes at 80° C., and was cooled down to room temperature. Thereafter, a sample piece was produced by punching with a JIS No. 3 dumbbell. The obtained sample piece was tested by tensile test according to JIS K6251 using a tensile tester (AGS-10k NG, manufactured by Shimadzu Corporation) at 50 mm/minute pulling speed, and the breaking strength (MPa) was measured. A pulling breaking strength greater than or equal to 10 MPa was evaluated as “∘”. A pulling breaking strength less than 10 MPa was evaluated as “x”. The evaluation results are shown in Table 1 below.

### Breaking Elongation

Each of the adhesive compositions prepared and obtained in the aforementioned manner was coated on a respective plastic plate at room temperature, was heated for 10 minutes at 80° C., and was cooled down to room temperature. Thereafter, a sample piece was produced by punching with a JIS No. 3 dumbbell. The obtained sample piece was tested by tensile test according to JIS K6251 using a tensile tester (AGS-10k NG, manufactured by Shimadzu Corporation) at 50 mm/minute pulling speed, and the breaking elongation (%) was measured. A pulling elongation greater than or equal to 150% was evaluated as “∘”. A pulling elongation less than 150% was evaluated as “x”. The evaluation results are shown in Table 1 below.

### Adhesivity

Each of the adhesive compositions prepared and obtained in the aforementioned manner was coated at room temperature onto one side of a respective electrodeposition coating plate (25×100×0.8 mm), and thereafter, two electrodeposition coating plates were glued and pressed together to form a respective bonded structural article. Thereafter, the bonded structural article was heated for 10 minutes at 80° C., and then was cooled down to room temperature to produce a respective bonded structural article. Length of the bonded part was 10 mm.

### Evaluation Method for Adhesivity

In accordance with JIS K6256, each of the bonded structural articles was subjected to 90° peeling test, and the breakage condition of the cured product of the adhesive composition was evaluated. The adhesivity evaluation criteria was following. The evaluation was “∘” when there was 100% cohesive failure of the cured product of the adhesive composition. The evaluation was “Δ” when there was interfacial peeling at 30% or less of the bonding surface area of the cured product of the adhesive composition. The evaluation was “x” when there was interfacial peeling for over 30% and less than or equal to 70% of the bonding surface area of the cured product of the adhesive composition. The evaluation results are shown in Table 1 below.

### Foaming Performance

Each of the adhesive compositions prepared and obtained in the aforementioned manner was coated at room temperature onto a respective electrodeposition coating plate, and thereafter, the plate was heated for 10 minutes at 80° C. and was cooled down to room temperature. Then the presence or absence of foaming was visually observed. The evaluation was “∘” when no visible foaming was found. The evaluation was “x” when visible foaming was found. The evaluation results are shown in Table 1 below.

TABLE 1

| | | Working | Working | Working | Working | Working | Working |
|---|---|---|---|---|---|---|---|
| | | Example 1 | Example 2 | Example 3 | Example 4 | Example 5 | Example 6 |
| Main | Polyol PPG | 70 | 60 | 50 | 70 | 60 | 50 |
| agent | 2000 | | | | | | |
| | Polyol PPG | — | — | — | — | — | — |
| | 1000 | | | | | | |
| | Polyol PPG 800 | — | — | — | — | — | — |
| | Polyol PPG 200 | 30 | 40 | 50 | 30 | 40 | 50 |
| | Carbon black | 25 | 25 | 25 | 25 | 25 | 25 |
| | Thermo- | 0.1 | 0.1 | 0.1 | — | — | — |
| | sensitive | | | | | | |
| | catalyst 1 | | | | | | |
| | Thermo- | — | — | — | 0.1 | 0.1 | 0.1 |
| | sensitive | | | | | | |
| | catalyst 2 | | | | | | |
| Curing | Polyisocyanate | 50.2 | 62.4 | 74.6 | 50.2 | 62.4 | 74.6 |
| agent | compound | | | | | | |

| | | | | | | |
|---|---|---|---|---|---|---|
| NCO/OH | 1.0 | 1.0 | 1.0 | 1.0 | 1.0 | 1.0 |
| OH value | 207.6 | 258.1 | 308.6 | 207.6 | 258.1 | 308.6 |
| Breaking strength | ∘ | ∘ | ∘ | ∘ | ∘ | ∘ |
| Breaking elongation | ∘ | ∘ | ∘ | ∘ | ∘ | ∘ |
| Adhesion | ∘ | ∘ | ∘ | ∘ | ∘ | ∘ |
| Foaming performance | ∘ | ∘ | ∘ | ∘ | ∘ | ∘ |

| | | Comparative | Comparative | Comparative | Comparative | Comparative |
|---|---|---|---|---|---|---|
| | | Example 1 | Example 2 | Example 3 | Example 4 | Example 5 |
| Main | Polyol PPG | — | — | 96 | 70 | 70 |
| agent | 2000 | | | | | |
| | Polyol PPG | 100 | — | — | — | — |
| | 1000 | | | | | |
| | Polyol PPG | — | 100 | — | — | — |
| | 800 | | | | | |
| | Polyol PPG | — | — | 4 | 30 | 30 |
| | 200 | | | | | |
| | Carbon black | 25 | 25 | 25 | 25 | 25 |
| | Thermo- | 0.1 | 0.1 | 0.1 | 0.1 | 0.1 |
| | sensitive | | | | | |
| | catalyst 1 | | | | | |
| | Thermo- | — | — | — | — | — |
| | sensitive | | | | | |
| | catalyst 2 | | | | | |
| Curing | Polyisocyanate | 27.1 | 33.9 | 18.4 | 37.6 | 62.7 |
| agent | compound | | | | | |

| | | | | | |
|---|---|---|---|---|---|
| NCO/OH | 1.0 | 1.0 | 1.0 | 0.75 | 1.25 |
| OH value | 112.2 | 140.3 | 76.3 | 207.6 | 207.6 |
| Breaking strength | x | ∘ | x | ∘ | ∘ |
| Breaking elongation | ∘ | x | ∘ | ∘ | ∘ |
| Adhesion | ∘ | ∘ | ∘ | x | ∘ |
| Foaming performance | ∘ | ∘ | ∘ | ∘ | x |

The components shown in Table 1 are as follows.
Polyol PPG 2000: Trade name = “EXCENOL 2020,” number average molecular weight = 2,000, manufactured by Asahi Glass Co., Ltd.
Polyol PPG 1000: Trade name = “EXCENOL 1020,” number average molecular weight = 1,000, manufactured by Asahi Glass Co., Ltd.
Polyol PPG 800: Trade name = “PPG-800,” number average molecular weight = 800, manufactured by Sanyo Chemical Industries, Ltd.
Polyol PPG 200: Trade name = “PPG-200,” number average molecular weight = 200, manufactured by Sanyo Chemical Industries, Ltd.
Carbon black: Trade name = “Niteron #200,” manufactured by Nippon Steel Chemical Carbon Co. Ltd.
Thermo-sensitive catalyst 1: Trade name = “U-CAT 1102,” DBN octylate, manufactured by San-Apro Ltd.
Thermo-sensitive catalyst 2: Trade name = “U-CAT 102-50,” DBU octylate, manufactured by San-Apro Ltd.
Polyisocyanate compound: Trade name = “Polymeric MDI PAPI-135,” manufactured by Dow Chemical Japan Ltd.

Based on the results shown in Table 1, each of the Working Examples 1 to 6 was found to have excellent breaking strength and breaking elongation. Also, adhesivity and foaming performance were confirmed to be excellent. In contrast, breaking strength was found to be poor for Comparative Example 1, which did not include the first multi-functional polyol having a number average molecular weight greater than or equal to 50 and less than or equal to 800. Breaking elongation was found to be poor for Comparative Example 2, which did not include the second multi-functional polyol having a number average molecular weight greater than or equal to 1,000 and less than or equal to 4,000. Breaking strength was found to be poor for Comparative Example 3, for which the content of the first multi-functional polyol having a number average molecular weight greater than or equal to 50 and less than or equal to 800, relative to the total amount of multi-functional polyols, was not in the range of greater than or equal to 5 mass % and less than or equal to 50 mass %. Adhesivity was found to be poor for Comparative Example 4, and forming performance was found to be poor for Comparative Example 5 for which the blended amount of the multi-functional isocyanate was such that the NCO/OH ratio was not in the range of greater than or equal to 0.8 and less than or equal to 1.2.

Thus, in comparison to each of the adhesive compositions of Comparative Examples 1 to 5, the cured products of each of the adhesive compositions of Working Examples 1 to 6 clearly had excellent breaking strength, breaking elongation, adhesivity, and foaming performance.

As in Working Examples 1 to 6, the adhesive composition of the present embodiment includes a urethane resin adhesive composition including: a urethane resin including at least two types of multi-functional polyols and at least one type of multi-functional isocyanate; and a thermo-sensitive catalyst functioning catalytically at a temperature greater than or equal to a predetermined temperature in a range greater than or equal to 20° C. and less than or equal to 90° C. The multi-functional polyols include: a first multi-functional polyol having a number average molecular weight greater than or equal to 50 and less than or equal to 800; and a second multi-functional polyol having a number average molecular weight greater than or equal to 1,000 and less than or equal to 4,000. Average OH values of the first multi-functional polyol and the second multi-functional polyol are greater than or equal to 150 and less than or equal to 800. A NCO/OH ratio of the multi-functional isocyanate is greater than or equal to 0.8 and less than or equal to 1.2. The obtained adhesive composition by this means clearly has high strength, high elongation, and excellent adhesivity.

1. A urethane resin adhesive composition comprising: a urethane resin comprising at least two types of multi-functional polyols and at least one type of multi-functional isocyanate; and a thermo-sensitive catalyst functioning catalytically at a temperature greater than or equal to a predetermined temperature in a range greater than or equal to 20° C. and less than or equal to 90° C.;
the multi-functional polyols comprising: a first multi-functional polyol having a number average molecular weight greater than or equal to 50 and less than or equal to 800; and a second multi-functional polyol having a number average molecular weight greater than or equal to 1,000 and less than or equal to 4,000; wherein
average OH values of the first multi-functional polyol and the second multi-functional polyol are greater than or equal to 150 and less than or equal to 800; and
a NCO/OH ratio of the multi-functional isocyanate is greater than or equal to 0.8 and less than or equal to 1.2.

2. The urethane resin adhesive composition according to claim 1, wherein the thermo-sensitive catalyst comprises at least one compound selected from the group consisting of 1,5-diazabicyclo[4,3,0]non-5-ene or salts thereof, and 1,8-diazabicyclo[5,4,0]undec-7-ene or salts thereof.

3. The urethane resin adhesive composition according to claim 1, wherein a content of the first multi-functional polyol relative to a sum of all of the multi-functional polyols is greater than or equal to 5 mass % and less than or equal to 50 mass %.

4. The urethane resin adhesive composition according to claim 1, wherein the urethane resin includes greater than or equal to 0.5 mass % and less than or equal to 5 mass % of isocyanate groups at the molecular terminals.

5. The urethane resin adhesive composition according to claim 4, wherein the isocyanate groups are bonded to aromatic hydrocarbons or aliphatic hydrocarbons.

6. The urethane resin adhesive composition according to claim 1, wherein the multi-functional isocyanate is a polyisocyanate having at least two isocyanate groups.

7. The urethane resin adhesive composition according to claim 6, wherein the polyisocyanate is an aromatic polyisocyanate.

8. The urethane resin adhesive composition according to claim 7, wherein the aromatic polyisocyanate includes TDI or MDI.

9. The urethane resin adhesive composition according to claim 6, wherein the polyisocyanate is an aliphatic polyisocyanate.

10. The urethane resin adhesive composition according to claim 9, wherein the aliphatic polyisocyanate includes HDI or XDI.

11. The urethane resin adhesive composition according to claim 6, wherein the polyisocyanate is an alicyclic polyisocyanate.

12. The urethane resin adhesive composition according to claim 11, wherein the alicyclic polyisocyanate includes IPDI.

13. The urethane resin adhesive composition according to claim 6, wherein the polyisocyanate is 4,4′-diphenylmethane diisocyanate.

14. The urethane resin adhesive composition according to claim 1, wherein the urethane resin is a resin obtained from polypropylene glycol and MDI.

15. The urethane resin adhesive composition according to claim 1, wherein the NCO/OH ratio of the multi-functional isocyanate is greater than or equal to 0.9 and less than or equal to 1.1.

16. The urethane resin adhesive composition according to claim 1, wherein the urethane resin adhesive composition is obtained by stirring and heating the multi-functional polyols and the multi-functional isocyanate at a temperature greater than or equal to 50° C. and less than or equal to 100° C.

17. The urethane resin adhesive composition according to claim 1, wherein the thermo-sensitive catalyst includes diazabicyclo-alkenes, phenol salts of diazabicyclo-alkenes or octylic acid salts of diazabicyclo-alkenes.

18. The urethane resin adhesive composition according to claim 1, an added amount of the thermo-sensitive catalyst per 100 parts by mass of the urethane prepolymer is greater than or equal to 0.05 parts by mass and less than or equal to 0.5 parts by mass of the multi-functional polyols.

19. The urethane resin adhesive composition according to claim 1, wherein the thermo-sensitive catalyst is an amine catalyst blended in an amount of greater than or equal to 0.05 parts by mass and less than or equal to 1.0 parts by mass of the multi-functional polyols.

20. The urethane resin adhesive composition according to claim 1, wherein the thermo-sensitive catalyst is a metal catalyst blended in an amount of greater than or equal to 0.05 parts by mass and less than or equal to 0.5 parts by mass of the multi-functional polyols.
